(19) United States
(12) Patent Application Publication
(10) Pub. No.: US 2026/0288373 A1
(43) Pub. Date: Sep. 24, 2026

(54) DATA TRANSFER BETWEEN BUFFERS

(71) Applicant: Micron Technology, Inc., Boise, ID (US)

(72) Inventor: Nitul Gohain, Bangalore (IN)

(21) Appl. No.: 19/564,914

(22) Filed: Mar. 12, 2026

(30) Foreign Application Priority Data
Mar. 20, 2025 (IN) 202541025629

(51) Int. Cl. G06F 3/06

(52) U.S. Cl. CPC G06F 3/0656; G06F 3/0613; G06F 3/0659; G06F 3/0679

(57) ABSTRACT

Methods, systems, and devices for data transfer between buffers are described. A memory system may be configured to transfer, from one or more memory devices of the memory system to a buffer of the memory system, a block of data that is associated with a memory management operation. The memory system may set a value of a flag associated with the buffer to a first value based on transferring the block of data to the buffer. The first value may indicate that the block of data satisfies a size threshold. The memory system may transmit the block of data to the host system based on the value of the flag associated with the buffer having the first value indicating that the block of data satisfies the size threshold.

### CROSS REFERENCE

The present Application for Patent claims the benefit of India Patent Application No. 202541025629 by Gohain, entitled “DATA TRANSFER BETWEEN BUFFERS,” filed Mar. 20, 2025, which is assigned to the assignee hereof, and is expressly incorporated by reference in its entirety herein.

### TECHNICAL FIELD

The following relates to one or more systems for memory, including data transfer between buffers.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIGS. 1 through 3 show examples of systems that support data transfer between buffers in accordance with examples as disclosed herein.

FIG. 4 shows a block diagram of a memory system that supports data transfer between buffers in accordance with examples as disclosed herein.

FIGS. 5 through 7 show flowcharts illustrating a method or methods that support data transfer between buffers in accordance with examples as disclosed herein.

### DETAILED DESCRIPTION

Some memory systems may utilize various data management methods to improve performance and resource utilization. For instance, a memory system (e.g., a not-and (NAND) system, a solid-state drive (SSD) system) may transfer data (e.g., garbage collection data, logical-to-physical (L2P) mapping data, metadata, cache data, and other data) from one or more memory devices (e.g., non-volatile memory devices, NAND memory devices, NAND dies) of the memory system to a host system (e.g., a peripheral component interconnect (PCI) host). In such cases, the host system may include a host memory buffer (HMB) that is utilized to store such data. This transfer of data may enable the memory system to free up storage resources (e.g., occupied by garbage collection data, L2P data, or other non-user) for applications associated with user data or other critical data, which may improve operational efficiency of the memory system.

However, in some cases, a transfer of data from the memory device(s) may be interrupted (e.g., stopped mid-stream, canceled, halted) due unexpected conditions, such as a receiving a reset command (e.g., a host reset command) or some other interruption. In these cases, the memory system (e.g., the circuitry responsible for handling the transfer of data to the host, such as host direct memory access (DMA) circuitry) may be pre-programmed with the transfer parameters (e.g., a size of data transfer, first buffer address, last buffer address, among other parameters), which may not be reset by the interruption. As such, the memory system may continue waiting for the data to arrive in a buffer (e.g., a temporary storage buffer (TSB), a data transfer buffer) from the memory devices even though the data transfer was canceled (e.g., and may not resume). The memory system may become unresponsive (e.g., “stuck” in a waiting state), and a full power cycle may be needed to remedy the issue, which may be both time-consuming and disruptive to the overall system operation and performance.

In accordance with one or more techniques described herein, a memory system may determine whether a block of data stored in a buffer (e.g., the TSB, the transfer buffer, a static random access memory (SRAM) buffer) satisfies a size threshold before the associated data is transmitted (e.g., by a host-DMA engine) to the host. For example, the memory system may (e.g., based on firmware instructions, based on a hardware implementation) set a value of a flag associated with the buffer (e.g., the TSB) after a complete block of data is successfully transferred to the buffer (e.g., and ready for transmission). As used herein, a complete block of data may refer to a block of data that satisfies a threshold (e.g., a size threshold, a data quantity threshold), indicating that the block of data is ready for further transfer to a host system.

In some examples, a size threshold for each transfer may be determined (e.g., by the memory system, preconfigured) and may be based on characteristics of the memory system (e.g., physical characteristics, such as a quantity of memory planes). By triggering data transmissions after a complete block of data has been transferred to the buffer (e.g., to the TSB), the memory system may reduce a likelihood of service interruptions, supporting improved reliability, improved performance, and reduced downtime. For example, an automotive system may employ a memory system in accordance with techniques herein, which may increase response times, improve safety system reliability, and provide other user experience enhancements.

In addition to applicability in memory systems as described herein, techniques for data transfer between buffers may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving memory access reliability, which may decrease processing or latency times, improve response times, or otherwise improve user experience, among other benefits.

Features of the disclosure are illustrated and described in the context of systems, devices, and circuits. Features of the disclosure are further illustrated and described in the context of flowcharts.

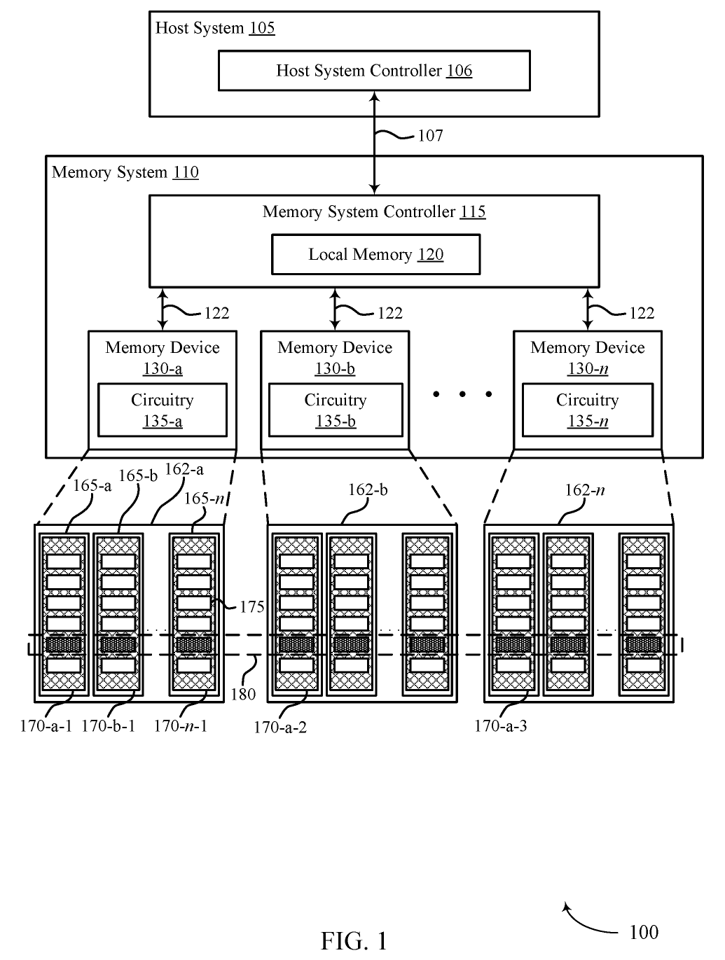

FIG. 1 shows an example of a system 100 that supports data transfer between buffers in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, an SSD, a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface 107 with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., PCIe controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via an interface 107. The host system 105 and the memory system 110 may, in some cases, be configured to communicate via the interface 107 using an associated protocol (e.g., to exchange or otherwise communicate control, address, data, and other signals between the memory system 110 and the host system 105). Examples of the interface 107 may include, but are not limited to, a SATA interface, a UFS interface, an eMMC interface, a PCIe interface, a USB interface, a Fiber Channel interface, a SCSI, a Serial Attached SCSI (SAS) interface, a Double Data Rate (DDR) interface, a DIMM interface (e.g., DIMM socket interface that supports DDR), an Open NAND Flash Interface (ONFI), Mobile Industry Processor Interface (MIPI) Unified Protocol (UniPro), MIPI Physical (M-PHY) interface, and a Low Power Double Data Rate (LPDDR) interface. In some examples, multiple such interfaces 107 may be included in or otherwise supported between a host system controller 106 of the host system 105 and a memory system controller 115 of the memory system 110 (e.g., the interface 107 may support communication via multiple protocol layers such as UFS at an application layer, UniPro at a transport layer, and M-PHY at a physical layer).

The memory system 110 may include a memory system controller 115 and one or more memory devices 130. A memory device 130 may include one or more memory arrays of any type of memory cells (e.g., non-volatile memory cells, volatile memory cells, or any combination thereof). The memory system 110 may include memory devices 130-a, 130-b, up to 130-n, where n represents any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the interface 107) and may be an example of a controller or control component configured to cause the memory system 110 to perform various operations in accordance with examples as described herein. The memory system controller 115 may also be coupled with and communicate with memory devices 130 via respective interfaces 122 to perform operations such as reading data, writing data, erasing data, or refreshing data at a memory device 130—among other such operations—which may generically be referred to as access operations. In some examples, the respective interfaces 122 may be examples of single data rate (SDR) interfaces, DRR interfaces, ONFI interfaces, and the like. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include volatile memory (e.g., SRAM, dynamic random access memory (DRAM), or other memory) that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or respective circuitry 135, which may be internal to memory devices 130, respectively, to perform the functions ascribed herein to the memory system controller 115. In general, one or more functions ascribed herein to the memory system controller 115 may, in some cases, be performed instead by the host system 105, circuitry 135, or any combination thereof. For example, the circuitry 135 may be or include a microcontroller, special purpose logic circuitry (e.g., an FPGA, an ASIC, a DSP), or any other suitable processor or processing circuitry. Thus, in some instances, “processor” or “processing circuitry” may refer to functions performed by the memory system controller 115, the host system 105, the circuitry 135 of one or more memory devices 130, or any combination thereof. In some cases, a memory system 110 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as DRAM memory cells or SRAM memory cells.

In some examples, a memory device 130 may include (e.g., on the same die, within the same package) circuitry 135, which may execute or otherwise support operations on one or more memory cells of the respective memory device 130. Respective circuitry 135 may operate in conjunction with a memory system controller 115 or may perform one or more functions ascribed herein to the memory system controller 115. For example, as illustrated in FIG. 1, a memory device 130-a may include circuitry 135-a, a memory device 130-b may include circuitry 135-b, and a memory device 130-n may include circuitry 135-n.

In some cases, a memory device 130 may be or include a NAND device (e.g., NAND flash device). A memory device 130 may be or include a die 162 (e.g., a memory die). For example, in some cases, a memory device 130 may be a package that includes one or more dies 162. A die 162 may, in some examples, be a piece of electronics-grade semiconductor cut from a wafer (e.g., a silicon die cut from a silicon wafer). The memory cells for each die 162 may be arranged in one or more planes 165, and each plane 165 may include one or more blocks 170, where each block 170 may include one or more pages 175, and each page 175 may include a set of memory cells. In some examples, each die 162 may include n planes 165 and each plane may include m blocks 170, where n and m represent positive integers.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, concurrent operations may be performed on different planes 165 or on different blocks 170. For example, concurrent operations may be performed on memory cells within different blocks 170 so long as the different blocks 170 are in different planes 165. In some examples, each memory die 162 may include any quantity of planes 165. For example, the memory die 162-a may include a plane 165-a, a plane 165-b, and a plane 165-n, where n represents an Nth plane. The memory die 162-b and the memory die 162-n may also include N planes. In some cases, an individual block 170 may be referred to as a physical block, and a virtual block 180 may refer to a group of physical blocks 170 within which concurrent operations may occur. A virtual block 180 may be a logical structure that includes a plurality of blocks, where different blocks of the plurality of blocks may come from different planes 165 or different memory dies 162. In some cases, a virtual block may include blocks 170 from different memory devices 130 (e.g., including blocks in one or more planes 165 of memory device 130-a, memory device 130-b, and memory device 130-n). In some examples, a virtual block may include a respective block from each plane 165 (e.g., a block 170 from each plane 165) of one or more memory dies 162.

In some cases, the blocks 170 within a virtual block may have the same block address within their respective planes 165. For example, block 170-a-1 may be “block 0” of a first plane of die 162-a, block 170-a-2 may be “block 0” of a first plane of die 162-b, block 170-a-3 may be “block 0” of a first plane of die 162-n, and so on. By way of further example, block 170-b-1 may be “block 1” of a first plane of die 162-a and block 170-n1 may be “block n” of die 162-a, where n represents an Nth block. The memory die 162-b and the memory die 162-n may also include N blocks. In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). For example, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be restricted from being re-written with new data until they are erased. Thus, for example, an invalid page 175 may, in some cases, not be updated until the entire block 170 that includes the page 175 has been erased.

In some cases, to update some data within a block 170 while retaining other data within the block 170, the memory device 130 may write the updated data to a new block 170. The memory device 130 (e.g., circuitry 135) or the memory system controller 115 may mark or otherwise designate the addresses of the data that was updated in the block 170 as invalid or obsolete and may update an L2P mapping table to associate the logical address (e.g., LBA) for the data with the new block 170 rather than the original block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by circuitry 135 or memory system controller 115.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system controller 115 or circuitry 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

The system 100 (e.g., a PCI system, a PCI express (PCIe) system, a non-volatile memory express (NVMe) system) may support data transfers across buffers of the host system 105 and the memory system 110. For instance, the memory system 110 and/or the memory system controller 115 may transfer data (e.g., garbage collection data, L2P mapping data, metadata, cache data, or other data) from one or more memory devices 130 (e.g., non-volatile memory devices, NAND memory devices, NAND dies) to an HMB of the host system 105 for temporary storage (e.g., due to a lack of a local memory 120 or insufficient storage of the local memory 120). This transfer of data may enable the memory system 110 to improve operational efficiency of the system 100. However, in some cases, a transfer of data from the memory device(s) 130 may be interrupted due unexpected conditions, such as a receiving a reset command from the host system 105. In these cases, the memory system 110 may continue waiting for data that may not arrive in a transfer buffer and may become “stuck” until a full power cycle is performed, resulting in significant downtime of the system 100.

In accordance with various techniques described herein, a memory system 110 may determine whether a block of data in a buffer (e.g., the TSB, an intermediate buffer between the memory device(s) 130 and the HMB) satisfies a size threshold before the associated data is transmitted (e.g., by a host-DMA engine) to the host system 105. For example, the memory system 110 may (e.g., based on firmware instructions, based on a hardware implementation) set a value of a flag associated with the buffer (e.g., the TSB) after an complete block of data is successfully transferred to the buffer (e.g., and ready for transmission). In some examples, a size threshold for each transfer may be determined (e.g., by the memory system 110, by the host system 105, preconfigured) and may be based on characteristics of the memory system 110 (e.g., physical characteristic, such as a quantity of memory planes). By triggering data transmissions after a complete block of data has been transferred to the buffer (e.g., to the TSB)(e.g., based on the flag value), the memory system may reduce a likelihood of service interruptions. Accordingly, the techniques described herein may enable memory systems and/or host systems to support improved reliability, improved performance, reduced downtime, and enhanced user experience, among other benefits.

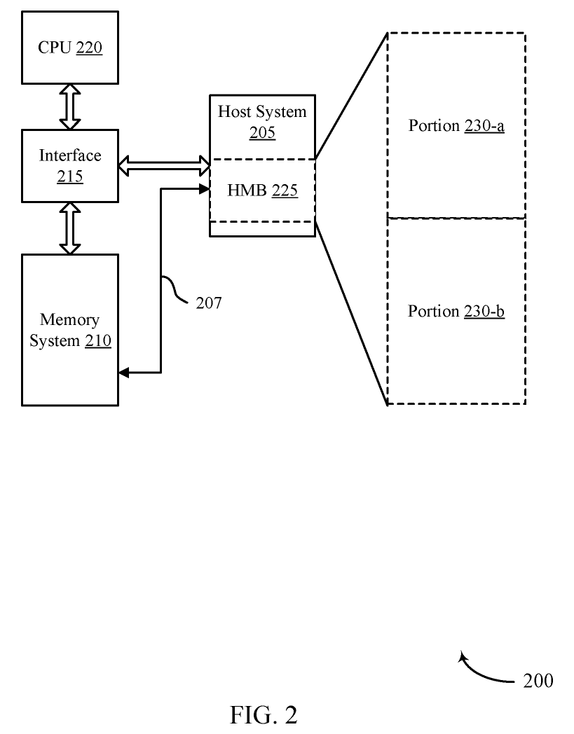

FIG. 2 shows an example of a system 200 that supports data transfer between buffers in accordance with examples as disclosed herein. The system 200 (e.g., which may be included as part of an automotive system) may include a memory system 210 (e.g., a PCIe SSD) and a host system 205 (e.g., a PCIe host). The memory system 210 and the host system 205 may be examples of or include corresponding devices as described herein (e.g., a memory system 110, a host system 105). The memory system 210 and the host system 205 may be in communication with (e.g., via one or more communicative couplings such as one or more busses, one or more conductive traces, or some other communicative path) an interface 215 (e.g., a PCIe root complex component). The interface 215 may facilitate communications (e.g., of one or more commands, data transfer, or other signaling) between the memory system 210 and/or the host system 205 and a central processing unit (CPU) 220. In some cases, the interface 215 may be included as part of another component in the system 200, such as the CPU 220, the memory system 210, or the host system 205.

The host system 205 may include various internal storage resources. For instance, the host system 205 may include an HMB 225 (e.g., a DRAM buffer, a 64 megabyte (MB) HMB DRAM) and other storage resources (e.g., system DRAM storage). The memory system 210 may include one or more memory devices (e.g., memory device(s) 130), which may store user data, application data, and other information. The memory system 210 and the host system 205 may be configured to communicate directly with each other via an interface 207 (e.g., an interface 107, one or more busses, one or more signal lines).

In some cases, signaling via the interface 207 (e.g., one or more of a read command, a write command, a configuration command, a mode register command, a data transfer) that occurs in a direction from the memory system 210 to the host system 205 may be referred to as “upstream” signaling, and signaling that occurs in a direction from the host system 205 to the memory system 210 may be referred to as “downstream” signaling. In some examples, the interface 207 may also support error correction and detection techniques (e.g., error correction code (ECC) techniques such as single-error correction double-error detection (SECDED), cyclic redundancy check (CRC) techniques such as CRC32), data encryption techniques (e.g., advanced encryption standard (AES) techniques), and other techniques that improve reliability and security of data transfers via the interface 207.

In some cases, the memory system 210 may transfer at least some of its stored data (e.g., non-user data) to the host system 205 (e.g., to the HMB 225) to allocate (e.g., create, free-up) additional storage space in its memory devices. For instance, to reduce design complexity and reduce cost, the memory system 210 may not include a local memory (e.g., an internal DRAM, memory separate from its NAND flash memory) that is utilized to store non-user data (e.g., metadata, data associated with a garbage collection operation or other memory management operation, L2P mapping data, cache data, or the like) or other data. Accordingly, the memory system 210 may transfer such data (e.g., garbage collection data, L2P mapping data) to be stored (e.g., temporarily) at the HMB 225 of the host system 205.

The HMB 225 (e.g., a buffer, such as a 64 MB buffer) may be organized into one or more physical or logical portions 230, such as the portion 230-a (e.g., a first 32 MB portion) and the portion 230-b (e.g., a second 32 MB portion) for storing various types of data. As an illustrative example, the portion 230-a may be used to store L2P mapping data (e.g., one or more LBAs, one or more physical addresses, pointer data), and the portion 230-b may be used to store garbage collection data (e.g., data that is to be relocated as part of a memory management operation by the memory system 210), cache data (e.g., the portion 23-b may be used by the memory system 210 as a data cache), user data, and other information.

However, in some cases, a transfer of a set data (e.g., a block of data) from the memory system 210 may be interrupted (e.g., stopped mid-stream, canceled, halted) before the full set of data is completed. For instance, the memory system 210 may receive a reset command from the host system 205 (e.g., a host reset command, a PCIe reset, an NVMe reset) or may experience some other interruption. In such cases, the memory system 210 (e.g., or a component thereof, such as logic, a memory system controller, or host-DMA) may continue to wait for the data to arrive in a buffer (e.g., a TSB) from the memory devices based on one or more transfer parameters (e.g., a size of data transfer, first buffer address, last buffer address, among other parameters), which may not be reset by the interruption. As such, the memory system 210 become non-responsive (e.g., “stuck” in a waiting state) due to the incomplete data transfer. In some cases, functionality of the memory system 210 may be restored based on a full power-cycle, but such methods may be time-consuming, disruptive, and may result in inefficient operation of the system 200.

In accordance with various techniques herein, the memory system 210 may include a flag (e.g., an internal buffer flag) indicating whether a complete block of data (e.g., in accordance with a size threshold, garbage collection data, L2P data, etc.) is ready for transmission to the host system 205. The memory system 210 (e.g., a memory system controller, based on firmware instructions or a hardware implementation) may set a value of the flag (e.g., by setting one or more bits to a given logic state) based on (e.g., after, in response to) transferring (e.g., communicating) a threshold quantity of data to a buffer (e.g., a TSB, a transfer buffer). The memory system 210 may check the value of the flag before triggering transmission (e.g., communication, by a host-DMA circuit) of the data to the host system 205. By triggering data transmissions based on the flag value, the memory system 210 may reduce a likelihood of service interruptions experienced by the system 200. Accordingly, the techniques described herein may enable the system 200 (e.g., included as part of an automotive system) to support improved reliability, improved performance, reduced downtime, and enhanced user experience, among other benefits.

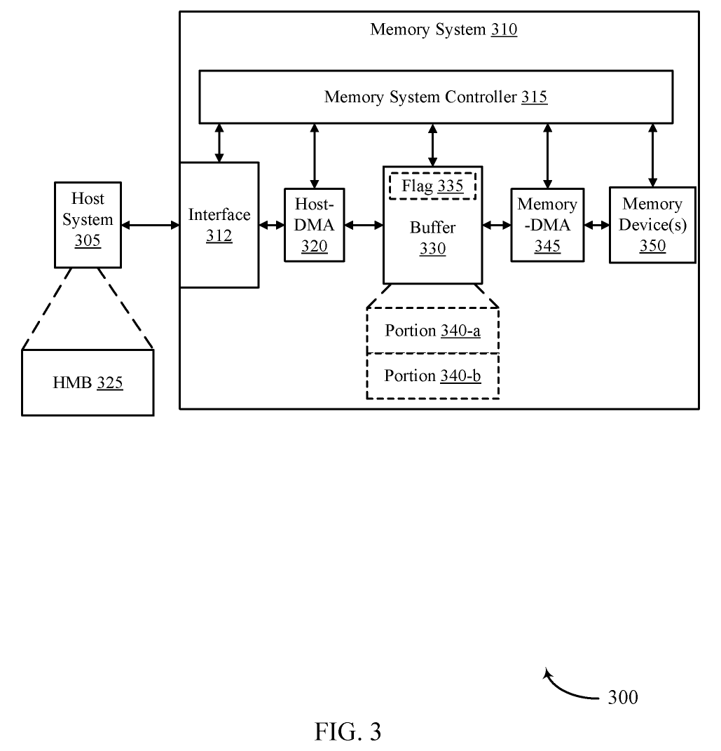

FIG. 3 shows an example of a system 300 that supports data transfer between buffers in accordance with examples as disclosed herein. The system 300 (e.g., which may be included as part of an automotive system) may include a memory system 310 and a host system 305. The memory system 310 and the host system 305 may be examples of or include corresponding devices as described herein, including as described with reference to FIGS. 1 and 2 (e.g., a memory system 110, a memory system 210, a host system 105, a host system 205). The memory system 310 may include a memory system controller 315 (e.g., a memory system controller 115), an interface 312 (e.g., a PCIe interface, an NVMe interface, an AES engine, an end-to-end (E2E) engine, or a combination thereof), a host-DMA 320 (e.g., a host-DMA circuit, a host-DMA engine), a buffer 330 (e.g., a TSB, SRAM, an SRAM ECC buffer, a data transfer buffer), a memory-DMA 345 (e.g., a memory-DMA circuit, a NAND-DMA engine, one or more memory devices 350 (e.g., memory device(s) 130, NAND flash memory, one or more NAND dies), as well as other components. The host system 305 may include one or more HMBs 325 (e.g., one or more HMBs 225) and other components (e.g., a host system controller 106). In some examples, the memory system controller 315 may be configured to (e.g., based on software or firmware instructions) cause the memory system 310, or the various components thereof, to perform any of the one or more operations described herein.

The interface 312 may facilitate communications between the host system 305 and the memory system 310. For example, the interface 312 may facilitate generating, translating, relaying, transmitting, receiving, or otherwise communicating signaling (e.g., control commands, read commands, write commands, data) from the memory system 310 to the host system 305 (e.g., upstream signaling) and/or from the host system 305 to the memory system 310 (e.g., downstream signaling). In some examples, the interface 312 may include various communication channels (e.g., inputs/outputs, one or more busses), which may facilitate both directions of signaling (e.g., upstream and downstream) concurrently. Additionally, or alternatively, the interface 312 may support data encryption and decryption functionality (e.g., via an AES engine), data protection functionality (e.g., via an E2E engine, CRC generation, CRC checks, bus data protection with CRC parity checks), and error correction functionality. Additionally, or alternatively, the one or more memory devices 350 may support various data protection techniques, including low density parity check (LDPC) codes or redundant array of independent disks (RAID) techniques (e.g., for user data protection), or Bose-Chaudhuri-Hocquenghem (BCH) codes (e.g., for metadata protection).

In some examples, the memory-DMA 345 may include a hardware component (e.g., an accelerator, logic circuitry) that manages the transfer of data from the one or more memory devices 350 to the buffer 330. The memory-DMA 345 may operate independently (e.g., without intervention of the memory system controller 315), for example, after being programmed with one or more source addresses (e.g., in the memory devices 350), one or more destination addresses (e.g., in the buffer 330), a quantity of data (e.g., a quantity of bytes, a size of data) to transfer, and other parameters. Additionally, or alternatively, the host-DMA 320 may include a hardware component (e.g., an accelerator, logic circuitry) that manages the transfer of data from the buffer 330 to the HMB 325. The host-DMA 320 may also operate independently (e.g., without intervention of the memory system controller 315), using programmed data transfer parameters such as source and destination addresses, a quantity of data for transfer, or the like.

The memory system 310 may utilize the buffer 330 as a temporary storage location to store data that is being transferred (e.g., as part of a memory management operation, such as garbage collection or L2P) from the one or more memory devices 350 to the host system 305. In some examples, the buffer 330 may include one or more portions 340 (e.g., sectors, one or more 512-byte portions, one or more 2-byte portion), which may be used to store (e.g., temporarily) different information. For example, the portion 340-a may store user data (e.g., in a 512-byte portion) and the portion 340-b may store CRC data (e.g., associated with the user data in the portion 340-a, in a 2-byte portion).

In some examples, when performing a memory management operation, the memory system 310 may reorganize data stored at the one or more memory devices 350. However, the memory system 310 may not include a local memory (e.g., local DRAM) and may thus utilize storage resources at the host system 305 (e.g., the HMB 325) to perform the operation. In some examples, a read path (e.g., a garbage collection source data path) for such data may include transferring data from the one or more memory devices 350 to the buffer 330 via the memory-DMA 345, followed by transferring data from the buffer 330 to the host system 305 (e.g., to the HMB 325) via the host-DMA 320. However, in some cases, such data transfers from the memory devices 350 to the HMB 325 may be interrupted mid-stream, which may result in performance degradation.

For instance, the memory-DMA 345 and the host-DMA 320 may begin to transfer a block of data (e.g., 16 KB of garbage collection data) from a memory device 350 to the HMB 325. In some examples herein, a “block” of data may refer to a set (e.g., or unit) of data that is associated with a given data transfer task. For instance, a block of data may be associated with a particular memory management operation (e.g., garbage collection) or a particular set of L2P data. In some cases, a block of data may correspond to a block 170 (e.g., equal to an entire block 170) or to a portion of one or more blocks 170 (e.g., a quantity of data that is greater than, or less than, an entire block 170).

Before all the data associated with the transfer operation (e.g., as pre-programmed in the DMA circuits) is transferred from the memory devices 350 to the buffer 330, the host system 305 may issue a reset command (e.g., during a time interval at which the memory-DMA 345 was reading source data from the memory devices 350). The reset command may may stop (e.g., cancel, halt, abort) the transfer operation by the memory-DMA 345. However, the host-DMA 320 may continue in accordance with its programming (e.g., in accordance with the transfer parameters) and wait for the next portion of data to be available in the buffer 330 for transfer to the HMB 325. That is, the HMB 325 may be expecting to transfer a specific quantity of data (e.g., without CPU interference or other controller interference). For instance, the host-DMA 320 and the memory-DMA 345 may operate concurrently (e.g., in parallel), and after triggering an HMB DMA transfer, if the memory-DMA 345 sends a single sector (e.g., 512 bytes) to the buffer 330, the host-DMA 320 may be configured to transmit the sector upstream to the HMB 325.

In such examples, the memory system 310 may become unresponsive (e.g., non-operational) until a power-cycle occurs (e.g., an internal CPU reset may not recover the host-DMA 320). These interruptions may occur in response to a host reset command, which the host system 305 may issue in response to detecting a time-out condition, a threshold quantity of errors detected by the host system 305, or some other undesired condition. As such, the system 300 may experience significant downtime to remedy the issue, which may lead to increased latency, increased processing overhead, and other adverse effects.

In accordance with the one or more techniques disclosed herein, the system 300 may support mechanisms to determine whether a block of data (e.g., a set of data to be transferred to the HMB 325) satisfies a size threshold (e.g., or a data quantity threshold) prior to initiating the data transfer to the HMB 325. In some examples, the buffer 330 (or some other component of the memory system 310) may include a flag 335 (e.g., a TSB buffer flag, an SRAM buffer flag, one or more bits, one or more register elements). A value of the flag 335 may indicate whether a block of data satisfies a size threshold or threshold quantity. Accordingly, before triggering the host-DMA 320 to transfer (e.g., communicate) data from the buffer 330 to the HMB 325, the memory system 310 (e.g., the memory system controller 315) may check (e.g., read) the value of the flag 335. If the value of the flag 335 is a first value (e.g., a first logic state, a “1”) the memory system 310 may transmit (e.g., communicate, transfer) the block of data stored in the buffer 330 to the host system 305. Alternatively, if the value of the flag 335 is a second value (e.g., a second logic state, a “0”) the memory system 310 may refrain from transmitting the block of data stored in the buffer 330 to the host system 305.

In some examples, the memory system 310 (e.g., the memory system controller 315, the memory-DMA 345, or other hardware) may (e.g., automatically) set the value of the flag 335 to the first value based on (e.g., upon, after, in response to) the quantity of data transferred to the buffer 330 satisfies the size threshold. Additionally, or alternatively, the memory system 310 may set the value of the flag 335 to the second value when the block of data is transferred (e.g., removed, flushed) from the buffer 330 to the HMB 325, or when the size (or quantity) of data in the buffer 330 fails to satisfy the size threshold. Accordingly, if the memory system 310 receives a host reset command (or experiences some other interruption) that terminates a data transfer operation by the memory-DMA 345, the memory system 310 may refrain from triggering the host-DMA 320 to transfer to the host system 305. That is, the memory system 310 may determine that a size of the data fails to satisfy the threshold, may maintain the flag 335 as the second value (e.g., may not set the flag), and may refrain from transmitting the data to the host system 305.

The size threshold (e.g., the data quantity threshold, a chunk size of each HMB data transfer via the host-DMA 320) may be configured (e.g., by the memory system 310, by the host system 305, pre-configured or hard-coded) to be any size and/or may correspond to any quantity of data (e.g., 16 KB, 32 KB, 64 KB, etc.). In some examples, the size threshold may be based on a quantity of planes (e.g., planes 165) associated with the one or more memory devices 350. As an illustrative example, the memory devices 350 may include four planes, and each plane may be associated with 16 KB of data to be transferred (e.g., for a garbage collection transfer). As such, a size threshold (e.g., a complete block of data) may be equal to 64 KB (e.g., 16 KB * 4 planes), which may ensure data integrity during DMA transmission.

In some examples, the transfer of data may be based on a memory management operation (e.g., a reorganization of data as part of a garbage collection procedure, an L2P mapping table update), which may be performed in response to one or more one or more commands (e.g., received from the host system 305, downstream commands). For example, the host system 305 may issue one or more sequential write commands and one or more random write commands, which may trigger the memory system 310 to perform a garbage collection operation (e.g., or some other memory management operation). Accordingly, the memory-DMA 345 may begin transferring data from the memory devices 350 to the buffer 330.

If a host reset command is received before the data transfer to the buffer 330 is complete, the data transfer may be terminated, and the data may not be transmitted to the HMB 325. Alternatively, if the full block of data (e.g., in accordance with the size threshold) is successfully transferred to the buffer 330 the flag 335 may be set (e.g., to a first value), and the host-DMA 320 may be triggered to transfer the full block of data (e.g., 64 KB) from the buffer 330 to the HMB 325. In some examples, the transfer of data to the HMB 325 may occur concurrently with the writing of other host data (or processing of other host commands). For example, the memory system 310 may receive one or more write commands from the host system 305 and may, concurrent with transmitting the block of data to the HMB 325, write the host data to the one or more memory devices 350.

Thus, by utilizing the flag 335 to coordinate the data transfer between the one or more memory devices 350 and the HMB 325 as described herein, the memory system 310 may improve performance and reliability. For example, the memory system 310 may be enabled to more reliably use the HMB 325 for garbage collection operations (e.g., garbage collection may not have to race to use the buffer 330 read and write operations), which may improve memory management performance. Moreover, relatively more space in the buffer 330 (e.g., more SRAM) may be available for host read and/or write operations, which may improve performance of the host system 305. Further, the memory system 310 may maintain data integrity even during scenarios of intervention by the host system 205 (e.g., host resets). As an illustrative example, an automotive system may employ the system 300, which may increase response times of the user interface, improve safety of the automotive system, and provide other user experience enhancements. As such, the system 300 may be enabled to support improved reliability, improved performance, reduced downtime, and enhanced user experience, among other benefits.

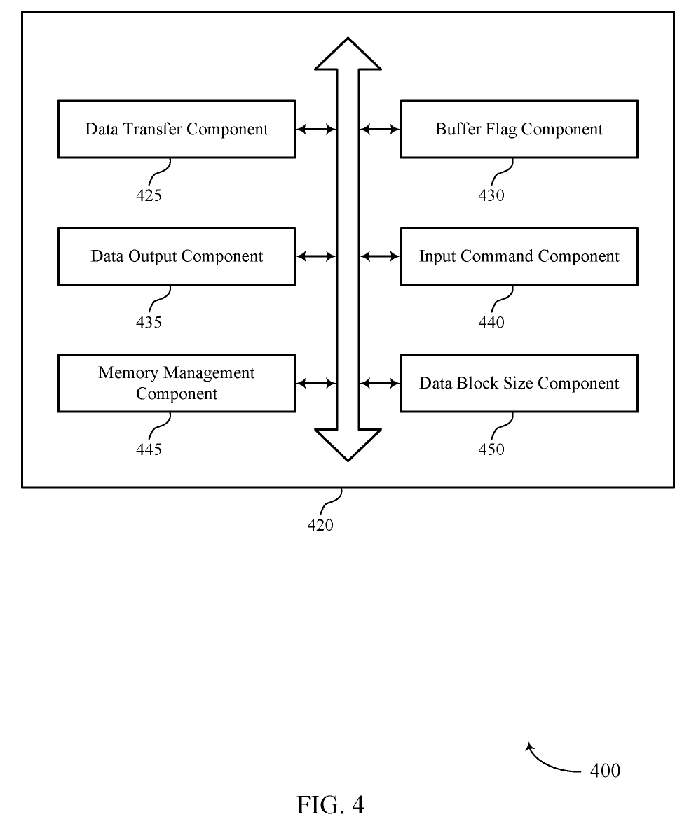

FIG. 4 shows a block diagram 400 of a memory system 420 that supports data transfer between buffers in accordance with examples as disclosed herein. The memory system 420 may be an example of aspects of a memory system as described with reference to FIGS. 1 through 3. The memory system 420, or various components thereof, may be an example of means for performing (e.g., to cause the memory system 420 to perform) various aspects of data transfer between buffers as described herein. For example, the memory system 420 may include a data transfer component 425, a buffer flag component 430, a data output component 435, an input command component 440, a memory management component 445, a data block size component 450, or any combination thereof. Each of these components, or components of subcomponents thereof (e.g., one or more processors, one or more memories), may communicate, directly or indirectly, with one another (e.g., via one or more buses).

The data transfer component 425 may be configured as or otherwise support a means for transferring, from a memory device of the memory system to a buffer of the memory system, a block of data that is associated with a memory management operation. The buffer flag component 430 may be configured as or otherwise support a means for setting a value of a flag associated with the buffer to a first value based at least in part on transferring the block of data to the buffer, where the first value indicates that the block of data satisfies a size threshold for the block of data being transmitted to a host system. The data output component 435 may be configured as or otherwise support a means for transmitting the block of data to the host system based at least in part on the value of the flag associated with the buffer having the first value indicating that the block of data satisfies the size threshold.

In some examples, the input command component 440 may be configured as or otherwise support a means for receiving one or more commands from the host system. In some examples, the memory management component 445 may be configured as or otherwise support a means for performing the memory management operation based at least in part on receiving the one or more commands, where transferring the block of data from the memory device to the buffer is in accordance with performing the memory management operation.

In some examples, the buffer flag component 430 may be configured as or otherwise support a means for setting the value of the flag associated with the buffer to a second value based at least in part on transmitting the block of data to the host system. In some examples, the data transfer component 425 may be configured as or otherwise support a means for transferring, from the memory device to the buffer, a portion of a second block of data that is associated with the memory management operation. In some examples, the data output component 435 may be configured as or otherwise support a means for refraining from transmitting the second block of data to the host system based at least in part on the flag being the second value.

In some examples, the input command component 440 may be configured as or otherwise support a means for receiving a reset command that terminates transferring the second block of data from the memory device to the buffer, where refraining from transmitting the second block of data to the host system is based at least in part on receiving the reset command.

In some examples, the second value indicates that the second block of data fails to satisfy the size threshold for being transmitted to the host system.

In some examples, the data block size component 450 may be configured as or otherwise support a means for determining that a size of the data fails to satisfy the size threshold for the second block of data being transmitted to the host system. In some examples, the buffer flag component 430 may be configured as or otherwise support a means for maintaining the value of the flag as the second value based at least in part on the size of the data failing to satisfy the size threshold for the second block of data being transmitted to the host system.

In some examples, the block of data is transferred from the memory device to the buffer via a first DMA circuit of the memory system. In some examples, the block of data is transmitted to the host system via a second DMA circuit of the memory system.

In some examples, the data block size component 450 may be configured as or otherwise support a means for determining that a size of the data satisfies the size threshold for the block of data being transmitted to the host system, where the value of the flag is set to the first value based at least in part on the size of the data satisfying the size threshold for the block of data being transmitted to the host system.

In some examples, the size of the block of data is based at least in part on a quantity of planes associated with the memory device.

In some examples, the input command component 440 may be configured as or otherwise support a means for receiving one or more commands from the host system to write data to the memory device. In some examples, the data transfer component 425 may be configured as or otherwise support a means for writing, concurrent with transmitting the block of data to the host system, the data to the memory device.

In some examples, the data output component 435 may be configured as or otherwise support a means for reading, by a controller of the memory system, the first value of the flag after setting the value of the flag to the first value, where transmitting the block of data to the host system is based at least in part on the controller reading the first value of the flag.

In some examples, the block of data that is associated with the memory management operation includes data associated with a garbage collection operation, data associated with logical-to-physical address mapping table, or a combination thereof.

In some examples, to support transmitting the block of data to the host system, the data output component 435 may be configured as or otherwise support a means for transmitting the block of data to a HMB of the host system.

In some examples, the value of the flag is set to the first value automatically based at least in part on the block of data satisfying the size threshold for the block of data being transmitted to a host system.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements) that are configured to cause the memory system 420 to perform one or more operations. In some examples, the described functionality of the memory system 420, or various components thereof, may be implemented at least in part by instructions (e.g., stored in memory, non-transitory computer-readable medium) executable by such at least one processor to cause the memory system 420 to perform one or more operations.

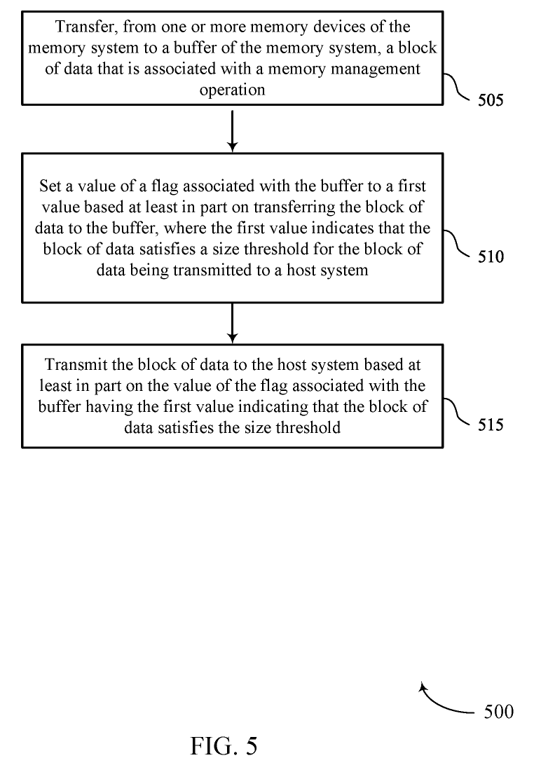

FIG. 5 shows a flowchart illustrating a method 500 that supports data transfer between buffers in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include transferring, from one or more memory devices of the memory system to a buffer of the memory system, a block of data that is associated with a memory management operation. In some examples, aspects of the operations of 505 may be performed by a data transfer component 425.

At 510, the method may include setting a value of a flag associated with the buffer to a first value based at least in part on transferring the block of data to the buffer, where the first value indicates that the block of data satisfies a size threshold for the block of data being transmitted to a host system. In some examples, aspects of the operations of 510 may be performed by a buffer flag component 430.

At 515, the method may include transmitting the block of data to the host system based at least in part on the value of the flag associated with the buffer having the first value indicating that the block of data satisfies the size threshold. In some examples, aspects of the operations of 515 may be performed by a data output component 435.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for transferring, from one or more memory devices of the memory system to a buffer of the memory system, a block of data that is associated with a memory management operation; setting a value of a flag associated with the buffer to a first value based at least in part on transferring the block of data to the buffer, where the first value indicates that the block of data satisfies a size threshold for the block of data being transmitted to a host system; and transmitting the block of data to the host system based at least in part on the value of the flag associated with the buffer having the first value indicating that the block of data satisfies the size threshold.

Aspect 2: The method, apparatus, or non-transitory computer-readable medium of aspect 1, further including operations, features, circuitry, logic, means, or instructions, or any combination thereof for receiving one or more commands from the host system and performing the memory management operation based at least in part on receiving the one or more commands, where transferring the block of data from the one or more memory devices to the buffer is in accordance with performing the memory management operation.

Aspect 3: The method, apparatus, or non-transitory computer-readable medium of any of aspects 1 through 2, further including operations, features, circuitry, logic, means, or instructions, or any combination thereof for setting the value of the flag associated with the buffer to a second value based at least in part on transmitting the block of data to the host system; transferring, from the one or more memory devices to the buffer, a portion of a second block of data that is associated with the memory management operation; and refraining from transmitting the second block of data to the host system based at least in part on the flag being the second value.

Aspect 4: The method, apparatus, or non-transitory computer-readable medium of aspect 3, further including operations, features, circuitry, logic, means, or instructions, or any combination thereof for receiving a reset command that terminates transferring the second block of data from the one or more memory devices to the buffer, where refraining from transmitting the second block of data to the host system is based at least in part on receiving the reset command.

Aspect 5: The method, apparatus, or non-transitory computer-readable medium of any of aspects 3 through 4, where the second value indicates that the second block of data fails to satisfy the size threshold for being transmitted to the host system.

Aspect 6: The method, apparatus, or non-transitory computer-readable medium of any of aspects 3 through 5, further including operations, features, circuitry, logic, means, or instructions, or any combination thereof for determining that a size of the data fails to satisfy the size threshold for the second block of data being transmitted to the host system and maintaining the value of the flag as the second value based at least in part on the size of the data failing to satisfy the size threshold for the second block of data being transmitted to the host system.

Aspect 7: The method, apparatus, or non-transitory computer-readable medium of any of aspects 1 through 6, where the block of data is transferred from the one or more memory devices to the buffer via a first DMA circuit of the memory system and the block of data is transmitted to the host system via a second DMA circuit of the memory system.

Aspect 8: The method, apparatus, or non-transitory computer-readable medium of any of aspects 1 through 7, further including operations, features, circuitry, logic, means, or instructions, or any combination thereof for determining that a size of the data satisfies the size threshold for the block of data being transmitted to the host system, where the value of the flag is set to the first value based at least in part on the size of the data satisfying the size threshold for the block of data being transmitted to the host system.

Aspect 9: The method, apparatus, or non-transitory computer-readable medium of aspect 8, where the size of the block of data is based at least in part on a quantity of planes associated with the one or more memory devices.

Aspect 10: The method, apparatus, or non-transitory computer-readable medium of any of aspects 1 through 9, further including operations, features, circuitry, logic, means, or instructions, or any combination thereof for receiving one or more commands from the host system to write data to the one or more memory devices and writing, concurrent with transmitting the block of data to the host system, the data to the one or more memory devices.

Aspect 11: The method, apparatus, or non-transitory computer-readable medium of any of aspects 1 through 10, further including operations, features, circuitry, logic, means, or instructions, or any combination thereof for reading, by a controller of the memory system, the first value of the flag after setting the value of the flag to the first value, where transmitting the block of data to the host system is based at least in part on the controller reading the first value of the flag.

Aspect 12: The method, apparatus, or non-transitory computer-readable medium of any of aspects 1 through 11, where the block of data that is associated with the memory management operation includes data associated with a garbage collection operation, data associated with logical-to-physical address mapping table, or a combination thereof.

Aspect 13: The method, apparatus, or non-transitory computer-readable medium of any of aspects 1 through 12, where transmitting the block of data to the host system includes operations, features, circuitry, logic, means, or instructions, or any combination thereof for transmitting the block of data to a HMB of the host system.

Aspect 14: The method, apparatus, or non-transitory computer-readable medium of any of aspects 1 through 13, where the value of the flag is set to the first value automatically based at least in part on the block of data satisfying the size threshold for the block of data being transmitted to a host system.

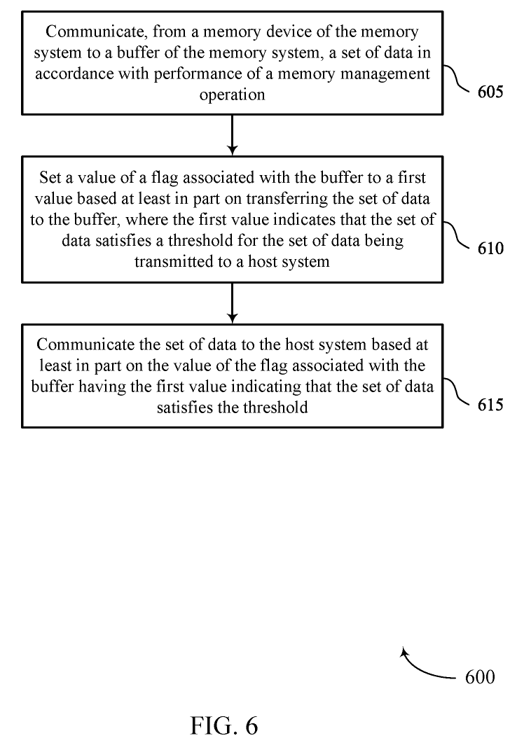

FIG. 6 shows a flowchart illustrating a method 600 that supports data transfer between buffers in accordance with examples as disclosed herein. The operations of method 600 may be implemented by a memory system or its components as described herein. For example, the operations of method 600 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 605, the method may include communicating, from a memory device of the memory system to a buffer of the memory system, a set of data in accordance with performance of a memory management operation. In some examples, aspects of the operations of 605 may be performed by the data transfer component 425.

At 610, the method may include setting a value of a flag associated with the buffer to a first value based at least in part on transferring the set of data to the buffer, where the first value indicates that the set of data satisfies a threshold for the set of data being transmitted to a host system. In some examples, aspects of the operations of 610 may be performed by the buffer flag component 430.

At 615, the method may include communicating the set of data to the host system based at least in part on the value of the flag associated with the buffer having the first value indicating that the set of data satisfies the threshold. In some examples, aspects of the operations of 615 may be performed by the data output component 435.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 15: A method, apparatus, or non-transitory computer-readable medium including operations, features, circuitry, logic, means, or instructions, or any combination thereof for communicating, from a memory device of the memory system to a buffer of the memory system, a set of data in accordance with performance of a memory management operation; setting a value of a flag associated with the buffer to a first value based at least in part on transferring the set of data to the buffer, where the first value indicates that the set of data satisfies a threshold for the set of data being transmitted to a host system; and communicating the set of data to the host system based at least in part on the value of the flag associated with the buffer having the first value indicating that the set of data satisfies the threshold.

Aspect 16: The method, apparatus, or non-transitory computer-readable medium of aspect 15, further including operations, features, circuitry, logic, means, or instructions, or any combination thereof for receiving one or more commands from the host system and performing the memory management operation based at least in part on receiving the one or more commands.

Aspect 17: The method, apparatus, or non-transitory computer-readable medium of any of aspects 15 through 16, further including operations, features, circuitry, logic, means, or instructions, or any combination thereof for setting the value of the flag associated with the buffer to a second value based at least in part on transmitting the set of data to the host system; communicating, from the memory device to the buffer, a portion of a second set of data that is associated with the memory management operation; and refraining from communicating the second set of data to the host system based at least in part on the flag being the second value.

Aspect 18: The method, apparatus, or non-transitory computer-readable medium of aspect 17, further including operations, features, circuitry, logic, means, or instructions, or any combination thereof for receiving a reset command that terminates transferring the second set of data from the memory device to the buffer, where refraining from communicating the second set of data to the host system is based at least in part on receiving the reset command.

Aspect 19: The method, apparatus, or non-transitory computer-readable medium of any of aspects 17 through 18, where the second value indicates that the second set of data fails to satisfy the threshold for being transmitted to the host system.

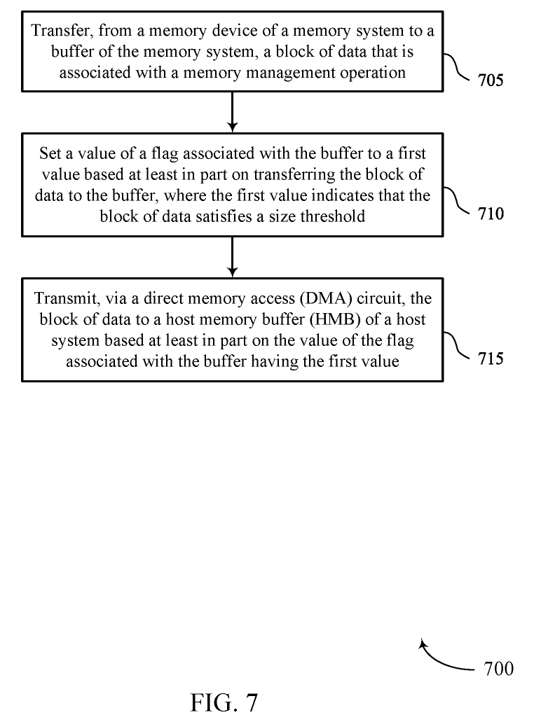

FIG. 7 shows a flowchart illustrating a method 700 that supports data transfer between buffers in accordance with examples as disclosed herein. The operations of method 700 may be implemented by a memory system or its components as described herein. For example, the operations of method 700 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 705, the method may include transferring, from a memory device of a memory system to a buffer of the memory system, a block of data that is associated with a memory management operation. In some examples, aspects of the operations of 705 may be performed by the data transfer component 425.

At 710, the method may include setting a value of a flag associated with the buffer to a first value based at least in part on transferring the block of data to the buffer, where the first value indicates that the block of data satisfies a size threshold. In some examples, aspects of the operations of 710 may be performed by the buffer flag component 430.

At 715, the method may include transmitting, via a direct memory access circuit, the block of data to a host memory buffer of a host system based at least in part on the value of the flag associated with the buffer having the first value. In some examples, aspects of the operations of 715 may be performed by the data output component 435.

In some examples, an apparatus as described herein may perform a method or methods, such as the method 700. The apparatus may include features, circuitry, logic, means, or instructions (e.g., a non-transitory computer-readable medium storing instructions executable by a processor), or any combination thereof for performing the following aspects of the present disclosure:

Aspect 20: A method, apparatus, or non-transitory computer-readable medium including operations, features, circuitry, logic, means, or instructions, or any combination thereof for transferring, from a memory device of a memory system to a buffer of the memory system, a block of data that is associated with a memory management operation; setting a value of a flag associated with the buffer to a first value based at least in part on transferring the block of data to the buffer, where the first value indicates that the block of data satisfies a size threshold; and transmitting, via a direct memory access circuit, the block of data to a host memory buffer of a host system based at least in part on the value of the flag associated with the buffer having the first value.

Aspect 21: The method, apparatus, or non-transitory computer-readable medium of aspect 20, further including operations, features, circuitry, logic, means, or instructions, or any combination thereof for receiving one or more commands from the host system and performing the memory management operation based at least in part on receiving the one or more commands, where transferring the block of data from the memory device to the buffer is in accordance with performing the memory management operation.

Aspect 22: The method, apparatus, or non-transitory computer-readable medium of any of aspects 20 through 21, further including operations, features, circuitry, logic, means, or instructions, or any combination thereof for setting the value of the flag associated with the buffer to a second value based at least in part on transmitting the block of data to the host system; transferring, from the memory device to the buffer, a portion of a second block of data that is associated with the memory management operation; and refraining from transmitting the second block of data to the HMB of the host system based at least in part on the flag being the second value.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

As used herein, the term “substantially” means that the modified characteristic (e.g., a verb or adjective modified by the term substantially) need not be absolute but is close enough to achieve the advantages of the characteristic.

As used herein, the term “electrode” may refer to an electrical conductor, and in some examples, may be employed as an electrical contact to a memory cell or other component of a memory array. An electrode may include a trace, wire, conductive line, conductive layer, or the like that provides a conductive path between elements or components of a memory array.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively, (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOS), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor’s threshold voltage is applied to the transistor gate. The transistor may be “off” or “deactivated” if a voltage less than the transistor’s threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, instructions (e.g., code, software, firmware, logic) executed by a processing system (e.g., one or more processors, one or more controllers, control circuitry, processing circuitry, logic circuitry), or any combination thereof that is configured to cause a respective apparatus, device, or system to perform the described functions. If implemented as instructions executed by a processing system, the functions may be stored on or transmitted over as one or more instructions on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof, that are configured to cause the performance of the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
transfer, from the one or more memory devices of the memory system to a buffer of the memory system, a block of data that is associated with a memory management operation;
set a value of a flag associated with the buffer to a first value based at least in part on transferring the block of data to the buffer, wherein the first value indicates that the block of data satisfies a size threshold for the block of data being transmitted to a host system; and
transmit the block of data to the host system based at least in part on the value of the flag associated with the buffer having the first value indicating that the block of data satisfies the size threshold.

2. The memory system of claim 1, wherein the processing circuitry is further configured to cause the memory system to:
receive one or more commands from the host system; and
perform the memory management operation based at least in part on receiving the one or more commands, wherein transferring the block of data from the one or more memory devices to the buffer is in accordance with performing the memory management operation.

3. The memory system of claim 1, wherein the processing circuitry is further configured to cause the memory system to:
set the value of the flag associated with the buffer to a second value based at least in part on transmitting the block of data to the host system;
transfer, from the one or more memory devices to the buffer, a portion of a second block of data that is associated with the memory management operation; and
refrain from transmitting the second block of data to the host system based at least in part on the flag being the second value.

4. The memory system of claim 3, wherein the processing circuitry is further configured to cause the memory system to:
receive a reset command that terminates transferring the second block of data from the one or more memory devices to the buffer, wherein refraining from transmitting the second block of data to the host system is based at least in part on receiving the reset command.

5. The memory system of claim 3, wherein the second value indicates that the second block of data fails to satisfy the size threshold for being transmitted to the host system.

6. The memory system of claim 3, wherein the processing circuitry is further configured to cause the memory system to:
determine that a size of the data fails to satisfy the size threshold for the second block of data being transmitted to the host system; and
maintain the value of the flag as the second value based at least in part on the size of the data failing to satisfy the size threshold for the second block of data being transmitted to the host system.

7. The memory system of claim 1, wherein:
the block of data is transferred from the one or more memory devices to the buffer via a first direct memory access (DMA) circuit of the memory system, and
the block of data is transmitted to the host system via a second DMA circuit of the memory system.

8. The memory system of claim 1, wherein the processing circuitry is further configured to cause the memory system to:
determine that a size of the data satisfies the size threshold for the block of data being transmitted to the host system, wherein the value of the flag is set to the first value based at least in part on the size of the data satisfying the size threshold for the block of data being transmitted to the host system.

9. The memory system of claim 8, wherein the size of the block of data is based at least in part on a quantity of planes associated with the one or more memory devices.

10. The memory system of claim 1, wherein the processing circuitry is further configured to cause the memory system to:
receive one or more commands from the host system to write data to the one or more memory devices; and
write, concurrent with transmitting the block of data to the host system, the data to the one or more memory devices.

11. The memory system of claim 1, wherein the processing circuitry is further configured to cause the memory system to:
read, by a controller of the memory system, the first value of the flag after setting the value of the flag to the first value, wherein transmitting the block of data to the host system is based at least in part on the controller reading the first value of the flag.

12. The memory system of claim 1, wherein the block of data that is associated with the memory management operation comprises data associated with a garbage collection operation, data associated with logical-to-physical address mapping table, or a combination thereof.

13. The memory system of claim 1, wherein transmitting the block of data to the host system comprises the processing circuitry configured to cause the memory system to:
transmit the block of data to a host memory buffer (HMB) of the host system.

14. The memory system of claim 1, wherein the value of the flag is set to the first value automatically based at least in part on the block of data satisfying the size threshold for the block of data being transmitted to a host system.

15. A method at a memory system, comprising:
communicating, from a memory device of the memory system to a buffer of the memory system, a set of data in accordance with performance of a memory management operation;
setting a value of a flag associated with the buffer to a first value based at least in part on transferring the set of data to the buffer, wherein the first value indicates that the set of data satisfies a threshold for the set of data being transmitted to a host system; and
communicating the set of data to the host system based at least in part on the value of the flag associated with the buffer having the first value indicating that the set of data satisfies the threshold.

16. The method of claim 15, further comprising:
receiving one or more commands from the host system; and
performing the memory management operation based at least in part on receiving the one or more commands.

17. The method of claim 15, further comprising:
setting the value of the flag associated with the buffer to a second value based at least in part on transmitting the set of data to the host system;
communicating, from the memory device to the buffer, a portion of a second set of data that is associated with the memory management operation; and
refraining from communicating the second set of data to the host system based at least in part on the flag being the second value.

18. The method of claim 17, further comprising:
receiving a reset command that terminates transferring the second set of data from the memory device to the buffer, wherein refraining from communicating the second set of data to the host system is based at least in part on receiving the reset command.

19. The method of claim 17, wherein the second value indicates that the second set of data fails to satisfy the threshold for being transmitted to the host system.

20. A non-transitory computer-readable medium storing code, the code comprising instructions executable by one or more processors to:
transfer, from a memory device of a memory system to a buffer of the memory system, a block of data that is associated with a memory management operation;
set a value of a flag associated with the buffer to a first value based at least in part on transferring the block of data to the buffer, wherein the first value indicates that the block of data satisfies a size threshold; and
transmit, via a direct memory access (DMA) circuit, the block of data to a host memory buffer (HMB) of a host system based at least in part on the value of the flag associated with the buffer having the first value.

21. The non-transitory computer-readable medium of claim 20, wherein the instructions are further executable by the one or more processors to:
receive one or more commands from the host system; and
perform the memory management operation based at least in part on receiving the one or more commands, wherein transferring the block of data from the memory device to the buffer is in accordance with performing the memory management operation.

22. The non-transitory computer-readable medium of claim 20, wherein the instructions are further executable by the one or more processors to:
set the value of the flag associated with the buffer to a second value based at least in part on transmitting the block of data to the host system;
transfer, from the memory device to the buffer, a portion of a second block of data that is associated with the memory management operation; and
refrain from transmitting the second block of data to the HMB of the host system based at least in part on the flag being the second value.
